(19) United States
(12) Patent Application Publication
(10) Pub. No.: US 2005/0249060 A1
(43) Pub. Date: Nov. 10, 2005

(54) Optical disk reading apparatus

(75) Inventors: Masahiko Arashi, Osaka (JP); Katsuo Tokuhara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/103,638

(22) Filed: Apr. 12, 2005

(30) Foreign Application Priority Data
Apr. 13, 2004 (JP) P2004-117996

(51) Int. Cl. G11B 7/00; G11B 7/09

(52) U.S. Cl. 369/44.27; 369/53.23

(57) ABSTRACT

An optical disk apparatus includes an information readout unit that reads out information recorded on an optical disk while seeking, a storage unit that temporarily stores the information read out, and a control unit that performs readout and seek controls for the information readout unit and performs readout and writing controls for the storage unit. When a readout error detection signal is inputted during reading out the information, the control unit seeks from a retry address preceding an error-detected address by a predetermined amount, and subsequently, when the readout error detection signal for the same address is inputted, seeks from a retry address further preceding the immediately preceding retry address by a predetermined amount. When the readout error detection signal is inputted on performing retry seek actions predetermined times, the control unit seeks from a head address of a video object unit preceding the error-detected address by a predetermined amount.

### BACKGROUND OF THE INVENTION

1. Field of the Invention

This invention relates to an optical disk apparatus for reading out and reproducing information recorded on an optical disk, and particularly to a retry action at the time of an information readout error of this optical disk apparatus.

2. Description of the Related Art

An optical disk apparatus for reading out and reproducing information recorded on an optical disk such as a DVD or a CD includes an apparatus for performing a retry readout action when information cannot be read out because a flaw is present on a recording surface of the optical disk, etc.

For example, as the optical disk apparatus for performing such a retry readout action, an apparatus for performing a seek action of reproduction from the portion which precedes an address at which a readout error is detected by a predetermined amount only when the readout error is detected at the time of reproduction of information recorded on an optical disk has been devised (see JP-A-2002-183972).

However, in the conventional optical disk apparatus described above, when an error is detected at a predetermined address and a seek action of reproduction is performed from an address which precedes this address by a predetermined amount, there are cases where information about the predetermined address cannot be read out even when information is read from the address which precedes by the predetermined amount depending on a state of a flaw etc. on a recording surface of an optical disk. Also, in the case that a readout error factor such as a flaw is also present in a record position of a recording surface corresponding to the address which precedes by the predetermined amount specified, the readout of information becomes more difficult. Then, in such a case, it is difficult to read out the information about the optical disk even when retry actions are performed repeatedly at this address which precedes by the predetermined amount.

### SUMMARY OF THE INVENTION

The present invention provides an optical disk apparatus capable of reading out information recorded on an optical disk more surely regardless of a state of the optical disk when a readout error occurs.

The invention is characterized in that in an optical disk apparatus including an information readout unit to read out information recorded on an optical disk while performing a seek action, a storage unit to temporarily store the information read out, and a control unit to perform readout control and seek control with respect to the information readout unit and performing readout control and writing control with respect to the storage unit, the control unit performs seek action control from a retry address which precedes an address at which an error is detected by a predetermined amount when a readout error detection signal is inputted from the information readout unit at the time of reading out the information on the optical disk, and subsequently performs seek action control from an address which is different from the previous retry address and precedes the address at which the error is detected when the readout error detection signal for the same address is inputted.

In this configuration, when a readout error detection signal is inputted at the time of seek action control, a control unit performs first retry seek action control for performing readout from an address which precedes an address (hereinafter called “an error initial detection address”) at which a readout error is detected by a predetermined amount. An information readout unit sequentially reads out information from an address specified by this first retry seek action control to the error initial detection address. Then, when the error detection signal is again inputted at the error initial detection address at the time of this first retry seek action control, the control unit performs second retry seek action control for performing readout from an address which precedes the error initial detection address unlike the address specified by the first retry seek action control. Then, the control unit performs the above retry seek action control over predetermined times or until information on the error initial detection address can be read out. As a result of this, the address specified by the retry seek action control, that is, the readout start address varies every time the retry readout is repeated. Since the information readout unit can read out information continuously recorded on a record track easier than information remotely recorded, the information on the error initial detection address becomes easy to read out by sequentially varying the readout start address and performing the retry readout.

Also, the invention is characterized in that the control unit performs seek action control from a retry address which precedes an address (error initial detection address) at which an error is detected by a predetermined amount when a readout error detection signal is inputted from the information readout unit at the time of reading out the information on the optical disk, and subsequently performs a seek action from a retry address which further precedes the immediately preceding retry address by a predetermined amount when the readout error detection signal for the same address is inputted.

In this configuration, when a readout error detection signal is inputted at the time of seek action control, a control unit performs first retry seek action control for performing readout from an address which precedes an error initial detection address by a predetermined amount, An information readout unit sequentially reads out information from an address specified by this first retry seek action control to the error initial detection address. Then, when the error detection signal is again inputted at the error initial detection address at the time of this first retry seek action control, the control unit performs second retry seek action control for performing readout from an address which further precedes the address specified by the first retry seek action control. Then, the control unit performs the above retry seek action control over predetermined times or until information on the error initial detection address can be read out. As a result of this, the address specified by the retry seek action control, that is, the readout start address varies every time the retry readout is repeated. Since the information readout unit can read out information continuously recorded on a record track easier than information remotely recorded, the information on the error initial detection address becomes easy to read out by sequentially varying the readout start address and performing the retry readout. Also, since the readout start address is specified sequentially from the address of the side near to the error initial detection address, time taken to perform a retry action is reduced in the case that readout is performed from the error initial detection address at the initial point in time of repeats of the retry action as compared with the case of randomly specifying the readout start address or specifying the readout start address from the remote side.

Also, the invention is characterized in that the control unit does not write the information on the address which precedes the address (error initial detection address) at which the error is detected among the information read out by the seek action from the retry address into the storage unit.

In this configuration, information ranging from the address which precedes the error initial detection address by a predetermined amount to the error initial detection address is inputted to the control unit by a retry seek action, but the information read out is different from information read out as a target of reproduction at present and is unnecessary information, so that the control unit does not store the information in the storage unit. As a result of this, only the necessary information obtained by the retry seek action is stored in the storage unit.

Also, the invention is characterized in that the control unit performs a seek action from an address which precedes the address (error initial detection address) at which the error is detected by a predetermined amount when the readout error detection signal is inputted at a point in time of performing retry seek actions predetermined times.

In this configuration, when an error is detected at the error initial detection address even in the case of performing retry seek actions from an address which precedes the error initial detection address predetermined times, the control unit decides that information on this address cannot be read out practically. Then, the control unit stops readout of the information on the error initial detection address and performs seek action control for reading out information on the preceding address which will have a higher possibility of readout than that of this error initial detection address. By forcedly ending the retry seek actions by the predetermined times thus, readout of the information on the error initial detection address is not continued semipermanently and information on the next specified address is read out. As a result of this, readout of the address at which readout cannot be performed practically due to a flaw etc. on a recording surface is not repeated semipermanently.

Also, the intention is characterized in that the control unit uses an address of the head of a video object unit in address detection of the case of performing a seek action from the address which precedes by the predetermined amount.

In this configuration, in the case of reading out information from the address which precedes the error initial detection address described above, the control unit specifies an address of the head of a video object unit different from a video object unit related to the error initial detection address. As a result of this, readout of the video object unit including information incapable of readout is omitted and readout is performed from the next video object unit with no problems.

According to the invention, a possibility of reading out information on an address at which an error is detected increases by reading out information from a readout start address varying every retry seek action. As a result of this, an optical disk apparatus for reading out information more surely regardless of a state of an optical disk can be configured.

Also, according to the invention, by sequentially performing specification from an address near to the address at which an error is detected at the time of a retry seek action, the effect described above is obtained and also, time necessary to perform a retry reading action can be reduced.

Also, according to the invention, among information acquired at a retry seek action, the information on an address which precedes the address at which an error is detected is not stored in storage unit, so that storage capacity of the storage unit can be utilized effectively and also time of writing into the storage unit is reduced and retry reading action time can be reduced.

Also, according to the invention, readout of information on an error detection address at which readout cannot be performed practically due to a flaw etc. on a recording surface is not continued semipermanently and information on the next specified address is read out and thereby, a retry seek action is omitted and retry seek action time can be reduced.

Also, according to the invention, readout of a video object unit including information on an error detection address at which readout cannot be performed practically is omitted and readout is performed from the next video object unit, so that a seek action is omitted and seek action time can be reduced.

### BRIEF DESCRIPTION OF THE DRAWINGS

FIG. 1 is a block diagram showing a schematic configuration of an optical disk apparatus according to an embodiment of the invention; and

FIG. 2 is a flowchart showing information readout processing of a control part 2 of the optical disk apparatus according to the embodiment of the invention.

### DETAILED DESCRIPTION OF THE INVENTION

An optical disk apparatus according to an embodiment of the invention will be described with reference to the drawings.

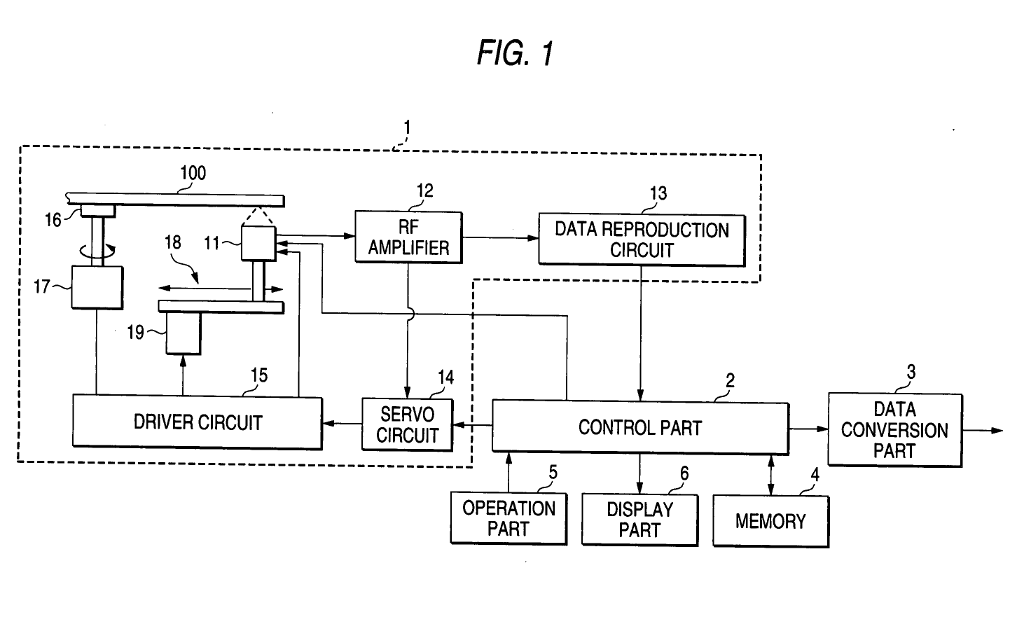

FIG. 1 is a block diagram showing a schematic configuration of an optical disk apparatus according to the present embodiment.

The optical disk apparatus includes an information readout part 1, a control part 2, a data conversion part 3, memory 4 corresponding to “storage unit” of the invention, an operation part 5 and an input part 6. The information readout part 1 includes an optical pickup 11, an RF amplifier 12, a data reproduction circuit 13, a servo circuit 14, a driver circuit 15, a turntable 16, a spindle motor 17, a traverse mechanism 18 and a stepping motor 19.

The optical pickup 11 includes a laser diode, a collimator lens, a beam splitter, an objective lens and a photodetector (not shown), and laser light is applied from the laser diode to an optical disk 100 and the reflected light from the optical disk 100 is converted into an electrical signal by the 10 photodetector and thereby information recorded on the optical disk 100 is optically read out. In the photodetector, for example, a light receiving area is approximately equally divided into four portions and electrical signals from the four light receiving areas are outputted to the RF amplifier 12. Also, the optical pickup 11 includes a focusing actuator (not shown) for moving a focal point of the laser light applied to the optical disk 100 in a direction of the optical axis and a tracking actuator (not shown) for moving the laser light in a radial direction of the optical disk 100. Then, by performing focusing control and tracking control, the laser light is made to follow a desired record track and also the laser light is focused on this record track.

The RF amplifier 12 amplifies a signal read out by the optical pickup 11 and outputs the signal to the data reproduction circuit 13 and also, generates a focusing error signal and a tracking error signal and outputs the error signals to the servo circuit 14.

The data reproduction circuit 13 reproduces information to digital data of a predetermined format by performing demodulation processing, error detection and correction processing, etc. to the signal outputted from the RF amplifier 12. Also, the data reproduction circuit 13 generates a signal indicating the number of revolutions of the optical disk 100 from the signal outputted from the RF amplifier 12 and outputs the signal to the servo circuit 14.

The servo circuit 14 generates a traverse driving signal, a tracking driving signal for setting a value of the TE signal at 0 (reference level) and a focusing driving signal for setting a value of the FE signal at 0 (reference level) based on the TE signal and the FE signal outputted by the RF amplifier 12, and outputs the signals to the driver circuit 15. Also, the servo circuit 14 generates a spindle motor driving signal for setting the number of revolutions of the optical disk 100 at a target value based on the signal indicating the number of revolutions of the optical disk 100 outputted by the data reproduction circuit 13, and outputs the signal to the driver circuit 15. Also, the servo circuit 14 generates a traverse driving signal for moving the optical disk 100 in a predetermined position based on a seek control signal inputted from the control part 2, and outputs the signal to the driver circuit 15.

The driver circuit 15 drives the focusing actuator of the inside of the optical pickup 11 based on the focusing driving signal, and drives the tracking actuator based on the tracking driving signal. Also, the driver circuit 15 drives the stepping motor 19 mounted in the traverse mechanism 18 for moving the optical pickup 11 in a radial direction of the optical disk 100 based on the traverse driving signal, and drives the spindle motor 17 for rotating the turntable 16 on which the optical disk 100 is placed at a predetermined number of revolutions based on the spindle motor driving signal.

The control part 2 is constructed of, for example, a microcomputer, and controls each component of the optical disk apparatus according to a command which a user inputs to the optical disk apparatus. Also, according to a reproduction operation command from the operation part 5, the control part 2 outputs a data readout control signal to the optical pickup 11 and also outputs a seek control signal for performing seek driving of the optical pickup 11 to the servo circuit 14 so that the laser light from the optical pickup 11 is applied to a predetermined address position of a record track of the optical disk 100. Also, the control part 2 temporarily stores digital data outputted from the data reproduction circuit 13 in the memory 4 and again reads out the digital data and outputs the digital data to the data conversion part 3.

The data conversion part 3 converts the inputted digital data into a signal according to specifications of an output terminal (not shown) and produces an output.

The operation part 5 is unit in which a user inputs various commands to the optical disk apparatus. The commands which the user inputs to the optical disk apparatus are outputted to the control part 2.

The display part 6 displays information indicating an action state of the optical disk apparatus, information about data in reproduction, etc.

By the way, there are cases where the optical disk apparatus cannot read out information recorded on an optical disk recording surface at the time of a seek action as shown in the conventional art described above. Therefore, in the optical disk apparatus of the invention, the following control is performed.

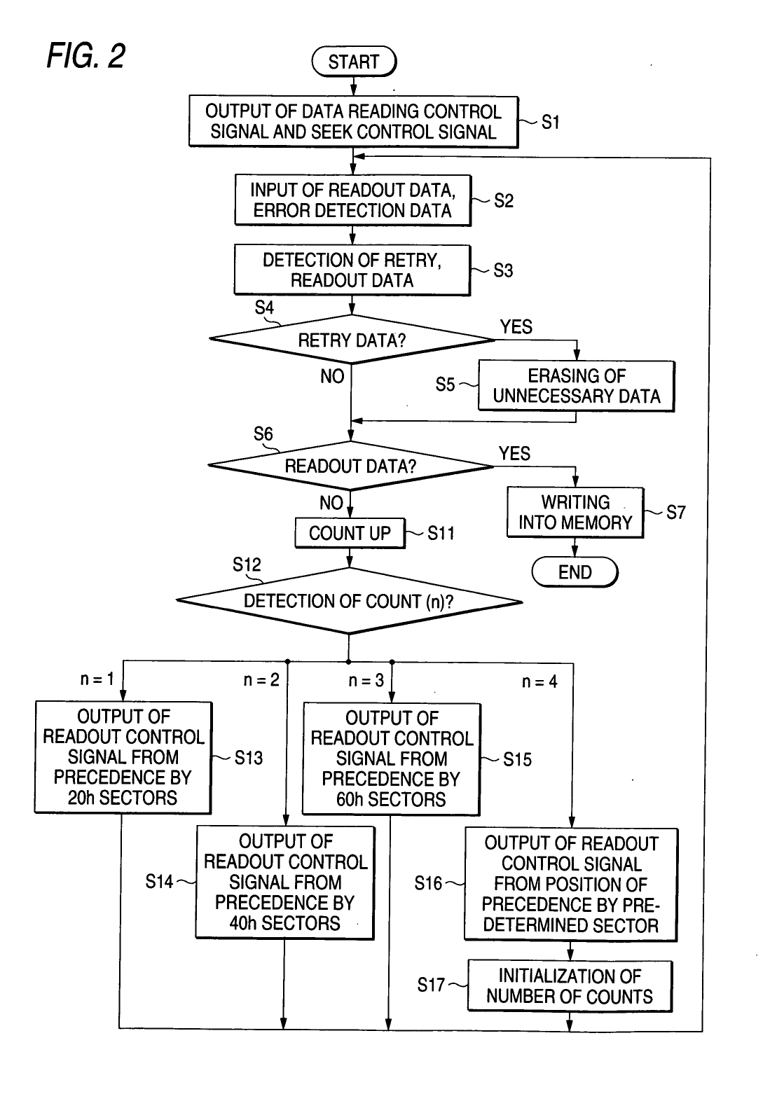

FIG. 2 is a flowchart showing information readout processing of the control part 2 of the optical disk apparatus according to the present embodiment.

When a data reproduction operation by the operation part 5 is inputted, the control part 2 generates a data readout control signal and outputs the signal to the optical pickup 11 and also generates a seek control signal and outputs the signal to the servo circuit 14 (S1). Then, the optical pickup 11 moves in a predetermined position and information is optically read out of an address of a predetermined sector of a record track of the optical disk 100. In this case, when information recorded on the optical disk 100 is read out, the information read out is reproduced by the data reproduction circuit 13 and is outputted to the control part 2. On the other hand, when the information recorded cannot be read out due to a flaw etc. of a recording surface of the optical disk 100, error detection data is outputted to the control part 2. Incidentally, a known method is used in an error detection method and its description is omitted. Next, the control part 2 detects whether or not this data input is done by retry seek control by the number of counts described below, etc. (S3) and when the input is done by the retry seek control, readout data corresponding to an address which precedes an error detection address is erased (S4→S5). Then, the control part 2 decides whether the input data is readout data or error detection data, and when the data is the readout data, the data is written into the memory 4 (S6→S7).

On the other hand, when the inputted data is the error detection data, the number of error detections is counted up (n=1) (S11) and the following processing according to this number of error detections is performed (S12).

(1) First, in the case of first error detection at a predetermined address (n=1), the control part 2 outputs a retry seek control signal for performing readout control from an address which precedes this error detection address by a predetermined amount (by 20 sectors in hexadecimal notation in the embodiment) to the servo circuit 14 (S13). According to this retry seek control signal, the servo circuit 14 generates a driving signal for moving the optical pickup 11 in a position corresponding to the address which precedes the error detection address by 20h sectors and outputs the driving signal to the driver circuit 15. According to this driving signal, the driver circuit 15 drives the stepping motor 19 and moves the optical pickup 11 in a predetermined position. Then, in this position, focus control and tracking control are performed and information recorded on the optical disk 100 is read out. In this case, the readout is performed from the address which precedes the error detection address, so that the control part 2 erases readout data read out of addresses ranging to the error detection address (S2→S3→S4→S5). Then, it is decided whether to be readout data or error detection data (S6), and in the case of being the readout data, the data is written into the memory 4.

(2) In the case that an error is detected even in the first retry seek control (n=2), the control part 2 outputs a retry seek control signal for performing readout control from an address which further precedes an address specified by the first retry seek control by a predetermined amount (precedes the specified address by 20 sectors in hexadecimal notation, that is, precedes the error detection address by 40 sectors in hexadecimal notation in the embodiment) to the servo circuit 14 (S14). Since driving control and readout control of each part are the same as those of the first retry seek control shown in (1) below, the description is omitted. Then, when readout data is acquired in second retry seek control, the control part 2 writes the readout data into the memory 4 (S6→S7).

(3) In the case that an error is detected even in the second retry seek control (n=3), the control part 2 outputs a retry seek control signal for performing readout control from an address which further precedes an address specified by the second retry seek control by a predetermined amount (precedes the specified address by 20 sectors in hexadecimal notation, that is, precedes the error detection address by 60 sectors in hexadecimal notation in the embodiment) to the servo circuit 14 (S15). Since driving control and readout control of each part are the same as those of the first and second retry seek control shown in (1) and (2) below, the description is omitted. Then, when readout data is acquired in third retry seek control, the control part 2 writes the readout data into the memory 4 (S6→S7).

(4) In the case that an error is detected even in the third retry seek control (n=4), the control part 2 outputs a jump seek control signal for performing readout control from an address which precedes the error detection address by a predetermined sector to the servo circuit 14 (S16). In this case, the control part 2 specifies an address of the head of a video object unit (VOBU) as a jump address. Then, the control part 2 initializes a count value (S17), and decides whether the input data is readout data or error detection data, and when the data is the readout data, the data is written into the memory 4 (S2→S3→S4→S6→S7). Then, when an error detection signal is inputted further, the control of (1) to (4) described above is repeated and the readout data is acquired.

Thus, information on the error detection address is sequentially read from plural different addresses which precede this error detection address and thereby, the information (readout data) on the error detection address can be acquired more surely than the case of repeatedly performing readout from the same position conventionally.

Also, by sequentially moving a readout start address away from the error detection address as the number of repeats increases, time taken to perform retry seek control can be reduced in the case that readout can be performed by a small number of repeats as compared with the case of sequentially moving the readout start address toward the error detection address from an address remotely distant from the error detection address or a method for randomly setting the readout start address.

Also, at the time of retry readout control, readout data recorded at an address which precedes the error detection address is not written into memory and thereby, memory capacity can be utilized effectively and also time of writing into memory can be reduced and thus, time taken to perform retry seek control can be reduced.

Also, by using a video object unit (VOBU) as the reference at the time of jump seek control, readout of an unreadout portion of the video object unit (VOBU) corresponding to the error detection address can be omitted and readout control time can be reduced.

Incidentally, in the embodiment described above, the readout start addresses have been set in order of 20 sectors, 40 sectors and 60 sectors in hexadecimal notation, but are not limited to these set values and can be set arbitrarily according to specifications of an apparatus etc.

Also, in the embodiment described above, the case that the number of sectors increased and set is the same in each retry seek control has been described, but the number of sectors increased may be varied respectively.

Further, in the embodiment described above, the case of switching to jump seek control by three-time retries has been described, but the number of retries may be plural times and the number of retries can be set arbitrarily.

1. An optical disk apparatus comprising:
an information readout unit that reads out information recorded on an optical disk while performing a seek action;
a storage unit that temporarily stores the information read out; and
a control unit that performs readout control and seek control with respect to the information readout unit and performs readout control and writing control with respect to the storage unit, wherein
when a readout error detection signal is inputted from the information readout unit at the time of reading out the information on the optical disk, the control unit performs a seek action from a retry address which precedes an address at which an error is detected by a predetermined amount, and subsequently, when the readout error detection signal for the same address is inputted, performs a seek action from a retry address which further precedes the immediately preceding retry address by a predetermined amount,
the control unit does not write the information on the address which precedes the address at which the error is detected among the information read out by the seek action from the retry address into the storage unit, and
when the readout error detection signal is inputted at a point in time of performing retry seek actions predetermined times, the control unit performs a seek action from an address of a head of a video object unit which precedes the address at which the error is detected by a predetermined amount.

2. An optical disk apparatus comprising:
an information readout unit that reads out information recorded on an optical disk while performing a seek action,
a storage unit that temporarily stores the information read out, and
a control unit that performs readout control and seek control with respect to the information readout unit and performing readout control and writing control with respect to the storage unit, wherein
the control unit performs a seek action from a retry address which precedes an address at which an error is detected by a predetermined amount when a readout error detection signal is inputted from the information readout unit at the time of reading out the information on the optical disk, and subsequently performs a seek action from an address which is different from the previous retry address and precedes the address at which the error is detected when the readout error detection signal for the same address is inputted.

3. The optical disk apparatus as claimed in claim 2, wherein
the control unit performs a seek action from a retry address which precedes an address at which an error is detected by a predetermined amount when a readout error detection signal is inputted from the information readout unit at the time of reading out the information on the optical disk, and subsequently performs a seek action from a retry address which further precedes the immediately preceding retry address by a predetermined amount when the readout error detection signal for the same address is inputted.

4. The optical disk apparatus as claimed in claim 2, wherein
the control unit does not write the information on the address which precedes the address at which the error is detected among the information read out by the seek action from the retry address into the storage unit.

5. The optical disk apparatus as claimed in claim 2, wherein
the control unit performs a seek action from an address which precedes the address at which the error is detected by a predetermined amount when the readout error detection signal is inputted at a point in time of performing retry seek actions predetermined times.

6. The optical disk apparatus as claimed in claim 5, wherein
the control unit uses an address of a head of a video object unit in address detection of the case of performing a retry seek action at the address which precedes by the predetermined amount.

7. An optical disk reading method of an optical disk apparatus which includes:
an information readout unit that reads out information recorded on an optical disk while performing a seek action;
a storage unit that temporarily stores the information read out; and
a control unit that performs readout control and seek control with respect to the information readout unit and performs readout control and writing control with respect to the storage unit, the method comprising:
when a readout error detection signal is inputted from the information readout unit at the time of reading out the information on the optical disk, performing a seek action from a retry address which precedes an address at which an error is detected by a predetermined amount, and subsequently, when the readout error detection signal for the same address is inputted, performing a seek action from a retry address which further precedes the immediately preceding retry address by a predetermined amount;
not writing the information on the address which precedes the address at which the error is detected among the information read out by the seek action from the retry address into the storage unit; and
when the readout error detection signal is inputted at a point in time of performing retry seek actions predetermined times, performing a seek action from an address of a head of a video object unit which precedes the address at which the error is detected by a predetermined amount.
